(19) United States
(12) Patent Application Publication
(10) Pub. No.: US 2014/0311614 A1
(43) Pub. Date: Oct. 23, 2014

(54) HIGH TEMPERATURE RESISTANT POLYSULFONE INSULATION FOR PIPE

(71) Applicant: SHAWCOR LTD., Toronto (CA)

(72) Inventors: Stephen J. Edmondson, Oakville (CA); Dennis Wong, Toronto (CA); Marcos Mockel, Buenos Aires (AR)

(73) Assignee: SHAWCOR LTD., Toronto (CA)

(21) Appl. No.: 14/193,663

(22) Filed: Feb. 28, 2014

Related U.S. Application Data
(60) Provisional application No. 61/770,557, filed on Feb. 28, 2013.

(51) Int. Cl. F16L 9/14

(52) U.S. Cl. CPC F16L 9/14
USPC 138/140; 29/460

(57) ABSTRACT

A polymeric composition for insulating fluid and/or gas transport conduits, such as off-shore oil and gas pipelines operating at temperatures of about 200° C. or higher in water depths above 1,000 metres. The outer surface of the conduit is provided with at least one layer of solid or foam insulation comprising a high temperature resistant polysulfone having sulfone, ether and isopropylidene bridging groups, and/or a polyphenylsulfone or a polyethersulfone.

### CROSS-REFERENCE TO RELATED APPLICATION

This application claims priority to and the benefit of U.S. Provisional Patent Application No. 61/770,557 filed Feb. 28, 2013, the contents of which are incorporated herein by reference.

### FIELD OF THE INVENTION

The present invention relates to polymeric compositions for insulating fluid and/or gas transport conduits, transport conduits insulated with these compositions, and methods for the production and application thereof. More particularly, the polymeric compositions according to the invention comprise high temperature resistant polysulfone thermoplastics having low thermal conductivity, high thermal softening point and high compressive creep resistance for use in the thermal insulation of fluid and/or gas transport conduits such as oil and gas pipelines.

### BACKGROUND OF THE INVENTION

There is increasing demand in the oil and gas industry for higher performance thermal coatings to insulate and protect off-shore transport conduits operating at temperatures above about 200° C., in water depths above 1,000 metres. In order to maintain the conduit at the required operating temperatures at these depths, the coatings must have low thermal conductivity to prevent the formation of hydrates and waxes that would compromise pumping efficiency of the fluid in the conduit. The thermal conductivity can be further decreased through foaming the coating to some required degree. The materials used in this application must also exhibit high softening point, high thermal stability, and high compressive creep resistance in order to withstand the operating temperatures and hydrostatic pressures acting on the coating in deep water pipe installations. Without sufficient compressive strength, the insulation will be compressed in thickness, thereby increasing thermal conductivity and altering the dimensions and the thermal and hydrodynamic performance of the system. Also, it is important that the coating remain sufficiently ductile after application to the conduit to prevent cracking during pipe handling and installation, for example during reeling onto a lay barge and subsequent deployment therefrom.

Multi-phase fluid flow is common in subsea fluid transport conduits, such as flowlines and risers. Two main concerns in such systems are the formation of gas-water hydrates and the deposition of wax. Both of these phenomena are related to the temperature of the fluid, and in extreme cases the conduit can become severely constricted or even blocked. This in turn can lead to reduced or lost production. In particularly serious cases this may lead to the need to replace sections of pipeline or entire systems with corresponding loss of asset value. Thermal insulation is used to provide controlled energy loss from the system either in steady state condition or in the case of planned and un-planned stoppage and thereby provide a reliable basis for operation.

For single-pipe flowlines and risers using bonded external insulation, the mechanical loads as well as the requirements placed on the mechanical and thermal performance of thermal insulation systems normally increase with water depth. Hence, the traditional thermal insulation foam technology used in shallow waters and the associated design and test methodologies may not be applicable to deep-water projects. In cases of long pipe tiebacks, for example subsea-to-beach tiebacks, and in cases where the service temperature is above approximately 150° C., there exist limitations with current technology that may hinder the successful development of offshore, deep water oil or gas fields.

Current technologies include single pipe solutions, typically with insulation requirements in the heat transfer coefficient range of 3-5 W/m² K, using polypropylene foam or polyurethane foam as the insulant, and so-called pipe-in-pipe systems wherein a second pipe surrounds the primary conduit, the annulus between the two pipes being filled with an insulating material.

Limitations and deficiencies of these technologies include:

Relatively high thermal conductivity of known insulating systems, necessitating excessively thick coatings to achieve the required insulation performance, leading to potential difficulties in foam processing, potential issues with residual stress, difficulties during pipe deployment, and sea-bed instability.

Insufficient resistance to temperatures above 200° C., resulting in compression and creep resistance issues in high temperature installations at high water depths.

Excessive costs due to poor material cost versus performance capabilities or high transportation and deployment costs.

Deployment and operation disadvantages with Pipe-In-Pipe systems due to weight factors leading to buckling and weld failure if not properly addressed, and the need for high gripping loads during pipe laying.

Although the high temperature resistant pipe insulation systems disclosed in U.S. Pat. No. 8,397,765 by Jackson et al. (incorporated herein by reference in its entirety) provide improved thermal performance over known insulation systems at operating temperatures of about 130° C. or higher, these thermoplastic-based insulation systems generally have insufficient resistance to temperatures above about 200° C.

Therefore, there remains a need for improved coatings for thermal insulation and protection of fluid and/or gas transport conduits such as oil and gas pipelines, particularly those operating at high temperatures in excess of about 200° C. in water depths above 1,000 metres.

### SUMMARY OF THE INVENTION

According to an embodiment, there is provided an insulated high-temperature transport conduit for use in offshore, deep water environments, the conduit comprising: (a) a continuous steel pipe made up of one or more pipe sections, wherein the steel pipe has an outer surface and an inner surface; (b) a corrosion protection layer provided over the outer surface of the steel pipe; and (c) a first thermal insulation layer provided over the corrosion protection layer, wherein the first thermal insulation layer comprises a polysulfone having a Vicat softening point greater than 200° C. and a thermal conductivity of less than about 0.40 W/mK.

In an embodiment, the polysulfone comprises phenyl groups bridged by sulfone, ether and isopropylidene bridging groups, for example the polysulfone may comprise a polyphenylsulfone.

In an embodiment, the first thermal insulation layer has a thickness of about 30 to about 70 mm, for example from about 40 to about 60 mm.

In an embodiment, the the first thermal insulation layer may be solid, or the first thermal insulation layer may be a blown foam or a syntactic foam having a degree of foaming of up to about 50%, for example from 5-30%.

In an embodiment, the first thermal insulation layer has one or more of the following properties: compressive creep resistance of less than about 10% at a temperature of about 205° C.; compressive modulus of at least about 1500 MPa; compressive strength of at least about 95 MPa; thermal conductivity of less than about 0.40 W/mK; and long term temperature withstand capability of at least about 200° C. For example, the polysulfone may have a Vicat softening point in the range of about 200-230° C. and a thermal conductivity of about 0.15-0.35 W/mK.

In an embodiment, the corrosion protection layer comprises an epoxy, such as a fusion-bonded epoxy. The fusion-bonded epoxy may be a high temperature fusion-bonded epoxy capable of continuous operation at about 200° C., or an epoxy novolac based coating capable of continuous operation at or above about 200° C.

In an embodiment, the corrosion protection layer is in contact with and bonded to the outer surface of the steel pipe.

In an embodiment, the insulated high-temperature transport conduit further comprises a primer layer which is in contact with and directly bonded to the outer surface of the steel pipe, wherein the corrosion protection layer is in contact with and bonded to the primer layer. The primer layer may comprise a phenolic primer such as a phenol-formaldehyde resin.

In an embodiment, the first thermal insulation layer is in contact with and bonded to the corrosion protection layer, and at least one of the corrosion protection coating and the first thermal insulation layer may be surface activated by a pretreatment before being bonded together. The pretreatment may comprise plasma or corona discharge.

In an embodiment, the first thermal insulation layer is bonded to the corrosion protection layer by an adhesive layer, which may comprise a hydroxyl-functionalized polyethersulfone.

In an embodiment, the insulated high-temperature transport conduit further comprises a second thermal insulation layer provided over the first thermal insulation layer, wherein the second thermal insulation layer is comprised of a thermoplastic in the form of a solid, a blown foam or a syntactic foam. The second thermal insulation layer is selected from the group comprising: polypropylene, polybutylene, polyethylene, polystyrene and copolymers, blends and elastomers thereof, wherein the polystyrene may comprise high impact polystyrene.

In an embodiment, the second thermal insulation layer may have a thickness of about 20 to about 70 mm, or about 30 to about 50 mm. The second thermal insulation layer may be solid, or a blown foam or a syntactic foam having a degree of foaming of up to about 50%, for example from 5-30%.

In an embodiment, the second thermal insulation layer has one or more of the following properties: compressive creep resistance of less than about 10% at a temperature of about 90° C. to about 140° C.; compressive modulus of at least about 1500 MPa; compressive strength of at least about 95 MPa; thermal conductivity of less than about 0.40 W/mK; and long term temperature withstand capability of at least about 90° C.

In an embodiment, the insulated high-temperature transport conduit further comprises an intermediate layer comprised of a polymeric material, wherein the intermediate layer is located between the first thermal insulation layer and the second thermal insulation layer. The polymeric material comprising the intermediate layer may be solid and/or it may comprise at least one styrenic component which may be selected from high impact polystyrene, a styrene-maleic anhydride copolymer, and blends thereof. The intermediate layer may have a thickness of about 2 to about 20 mm, or about 5 to about 15 mm, and may have one or more of the following properties: density of about 1030-1050 kg/m3; Vicat softening point of at least about 125° C.; and long term temperature withstand capability of at least about 120° C.

In an embodiment, the the intermediate layer is in contact with and bonded to one or both of the first thermal insulation layer and the second thermal insulation layer. Where the intermediate layer is in contact with and bonded to the first thermal insulation layer, at least one of the intermediate layer and the first thermal insulation layer may be surface activated by a pretreatment before being bonded together. Where the intermediate layer is in contact with and bonded to the second thermal insulation layer, at least one of the intermediate layer and the second thermal insulation layer may be surface activated by a pretreatment before being bonded together. The pretreatment may comprise surface treatment by plasma or corona discharge.

In an embodiment, the intermediate layer is bonded to one or both of the first thermal insulation layer and the second thermal insulation layer by an adhesive layer.

In an embodiment, the insulated high-temperature transport conduit further comprises an outer protective topcoat comprising an outermost layer of the conduit and provided over the second thermal insulation layer, wherein the outer protective topcoat comprises a thermoplastic polymer. The outer protective topcoat is solid.

In an embodiment, the outer protective topcoat comprises at least one styrenic component or polypropylene. Where the outer protective topcoat is styrenic, the at least one styrenic component may be selected from polyethylene-modified polystyrene, styrene-butadiene block copolymer, and blends thereof. The outer protective topcoat may further comprise one or more additives selected from antioxidants and pigments. The outer protective topcoat may have a thickness of about 1 to about 10 mm, or about 3 to about 5 mm.

In an embodiment, the outer protective topcoat is in contact with and bonded to the second thermal insulation layer, and at least one of the outer protective topcoat and the second thermal insulation layer may be surface activated by a pretreatment before being bonded together, wherein the pretreatment may comprise surface treatment by plasma or corona discharge. Alternatively, the outer protective topcoat may be bonded to the second thermal insulation layer by an adhesive layer.

In an embodiment, there is provided a process for preparing an insulated high-temperature transport conduit, comprising: (a) providing a cylindrical substrate having an outer surface; (b) extruding a sheet comprising a polysulfone polymer having a Vicat softening point greater than 200° C., the sheet having an inner surface and an outer surface; (c) wrapping the sheet of polysulfone polymer around the cylindrical substrate so as to bring the inner surface of the sheet of polysulfone polymer into contact with the outer surface of the cylindrical substrate; wherein, during said wrapping step, the inner surface of the sheet of polysulfone is activated by a pretreatment immediately before it is brought into contact with the outer surface of the cylindrical substrate. The pretreatment may comprise surface treatment by plasma or corona discharge

In an embodiment, both the outer surface of the cylindrical substrate and the sheet of polysulfone polymer are at a temperature above the Vicat softening point of the polysulfone polymer during the wrapping step.

In an embodiment, the sheet is wrapped around the cylindrical substrate in overlapping fashion and in a plurality of layers.

In an embodiment, the cylindrical substrate comprises a steel pipe and the outer surface of the cylindrical substrate comprises a corrosion protection layer. The corrosion protection layer may comprise a fusion-bonded epoxy and the polysulfone comprises a polyphenylsulfone.

### BRIEF DESCRIPTION OF THE DRAWINGS

The invention will now be described, by way of example only, with reference to the accompanying drawings in which:

FIG. 1 is a transverse cross-section of an insulated pipeline according to a first embodiment of the invention;

FIG. 2 is a transverse cross-section of an insulated pipeline according to a second embodiment of the invention;

FIG. 3 is a longitudinal cross-section of the pipe joint area of 2 insulated pipelines welded together;

FIGS. 4 and 5 are graphs of thermal conductivity vs. temperature for a number of samples of polysulfone insulation; and

FIG. 6 is a graph of temperature and Q value vs. time, to demonstrate long-term performance of an insulation system in accordance with the invention.

### DETAILED DESCRIPTION OF PREFERRED EMBODIMENTS

The present invention relates to insulating and protective coatings and thermally insulated fluid and/or gas transport conduits (also referred to herein as “pipelines”) incorporating said coatings for use in subsea environments. The present invention also relates to methods of manufacturing said insulating and protective coatings and for manufacturing thermally insulated high-temperature fluid and/or gas transport conduits incorporating said coatings.

The term “high temperature” as used herein refers to operating temperatures or service temperatures which are greater than about 200° C., for example in the range from above 200° C. to about 270° C., or in the range from about 200-230° C. For example, an insulated transport conduit according to the invention may be designed to carry fluids at temperatures in excess of 200° C., for example at a temperature of about 205° C., in water at a temperature of about 5° C.

The term “solid” as used herein with reference to one or more of the layers of an insulated transport conduit means that the layers are substantially unfoamed, i.e. solid layers as defined herein have a degree of foaming of about 0%, and do not incorporate microspheres as would be present in syntactic foams. Unfoamed layers may be filled or unfilled, wherein optional fillers include glass fibers.

The term “foam” as used herein includes both blown foams and syntactic foams, as defined in the following description.

The fluid and/or gas transport conduits described below are oil and gas pipelines which are typically made up of one or more steel pipe sections. The term “fluid and/or gas transport conduits”, and similar terms as used herein, are intended to include such oil and gas pipelines and related components, including flowlines, risers, jumpers, spools, manifolds and ancillary equipment.

A major consideration in the use of steel pipe is protection of the pipe from long-term corrosion in humid and high-temperature service conditions. Therefore the insulating and protective coatings according to the invention comprise a corrosion protection layer which is applied over a blasted and cleaned steel pipe prior to the application of any thermal insulation layers, including the at least one layer of high temperature resistant polysulfone according to the invention.

It will be appreciated that layers making up the insulating and protective coatings described below are not shown to scale in the drawings. In particular, the thicknesses of some of the layers making up the coatings are exaggerated in relation to the thicknesses of the other layers and also relative to the thickness and diameter of the steel pipe.

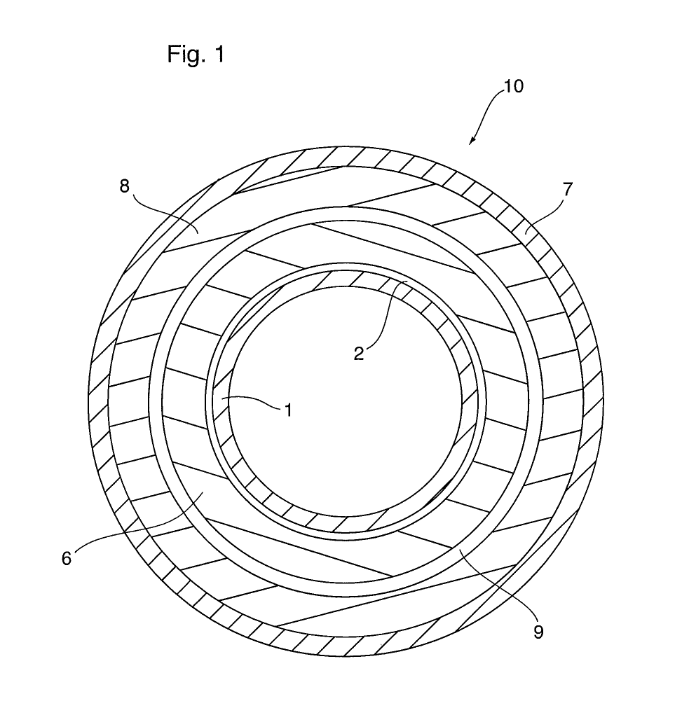

FIG. 1 illustrates a transverse cross-section of an insulated oil and gas pipeline 10 according to a first embodiment of the invention. The insulated pipeline 10 includes one or more sections of steel pipe 1 having an outer surface and an inner surface. A corrosion protection layer 2 is provided over the outer surface of the steel pipe 1, the corrosion protection layer being comprised of a high temperature resistant corrosion protection material as described below, which is able to withstand operating temperatures above 200° C. throughout the lifetime of pipeline 10. The thickness of the corrosion protection layer 2 will typically be up to about 1 mm, more typically up to about 0.5 mm.

In the embodiment of FIG. 1, the corrosion protection layer 2 is applied directly to the outer surface of the steel pipe 1, such that the corrosion protection layer 2 is in contact with and bonded to the outer surface of the steel pipe 1.

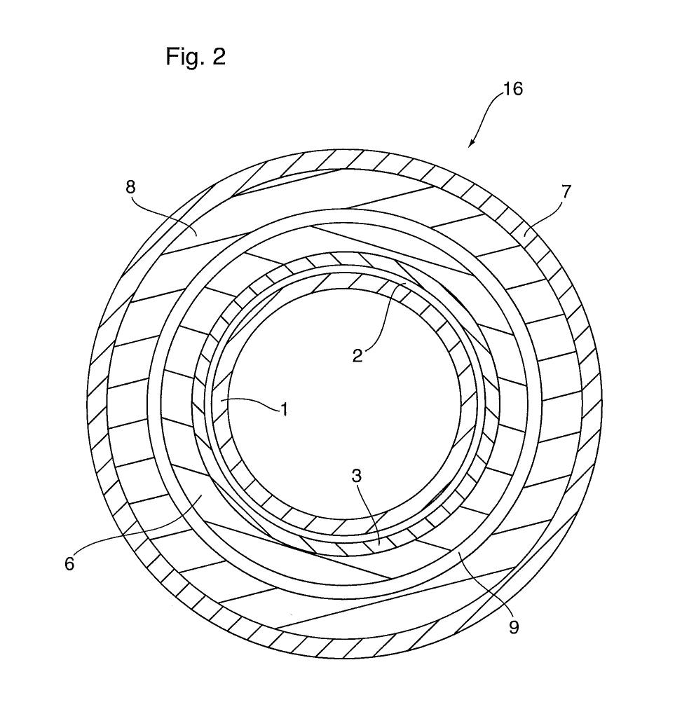

FIG. 2 illustrates an insulated oil and gas pipeline 16 according to a second embodiment of the invention, in which the pipeline further comprises a primer layer 3 which is applied directly to the outer surface of the steel pipe 1, such that the primer layer 3 is in contact with and bonded to the outer surface of the steel pipe 1.

In the embodiment of FIG. 2, the primer layer 3 is located between the pipe 1 and the corrosion protection layer 2, with the corrosion protection layer 2 being in contact with and bonded to the outer surface of the primer layer 3.

The insulated oil and gas pipelines according to the invention also comprise one or more thermal insulation layers, which include one or more foamed layers and/or one or more unfoamed, solid layers. The pipeline 10 illustrated in FIG. 1 includes a first (inner) thermal insulation layer 6 and second (outer) thermal insulation layer 8. At least the first thermal insulation layer 6 comprises a polysulfone having a Vicat softening point (i.e. softening temperature) greater than 200° C. and a thermal conductivity of less than about 0.40 W/mK. It will be appreciated that insulated oil and gas pipelines according to the invention may comprise more than two layers of thermal insulation, each of which may be foamed or solid.

The first thermal insulation layer 6 must firmly adhere to said corrosion protection layer 2. This is a particularly important consideration if the thermal insulation layer 6 and the underlying corrosion protection layer 2 are comprised of dissimilar polymeric materials. Adhesion between the layers, also known as interlayer adhesion, is also dependant upon the coating temperature and the mode of application of the layers. For example, it may be necessary to pre-heat the corrosion protection layer 2 prior to the application of the first thermal insulation layer 6 to better fuse the two layers together and maximize interlayer adhesion. It may also be necessary to apply an adhesive layer 4 (discussed further below) between the corrosion protection layer 2 and the first thermal insulation layer 6. In the embodiment of FIG. 1, the first thermal insulation layer 6 is in contact with and bonded to the corrosion protection layer 2 without the aid of an adhesive layer.

Interlayer adhesion may also be accomplished by surface activation of one or more of the surfaces to be adhered. Surface activation is accomplished by a pretreatment which activates a surface by forming or attaching functional or polar chemical groups to the surface. For example, oxidation of a surface is an effective and well-known pretreatment method. One common method of accomplishing this is to expose the polyolefin surface to an oxygen-rich flame. Another way is to expose the surface to a corona discharge, which contains oxygen radicals capable of creating oxygenated species, such as hydroxyl, carbonyl, and carboxylic acid groups on the surface.

It is also well known to activate a polymer surface by exposing it to high-energy gas plasma, which creates highly reactive species from the ionized gas. The plasma is typically generated by forcing a stream of gas between electrodes. The plasma is composed of ions, radicals, neutral species, and highly energetic electrons. The active species react with the surface of the layer undergoing pretreatment to create polar functional groups thereon. The types of polar functional groups formed on the substrate surface depend on the ionizable gas selected. For example, if an oxygen-containing gas is used, oxygen-containing functional groups such as those listed above will be formed, whereas if a nitrogen-containing gas is used, nitrogen-containing functional groups, such as amine groups, will be formed. Suitable gases include but are not limited to: oxygen-containing gases and/or aerosols, such as oxygen (O₂), carbon dioxide (CO₂), carbon monoxide (CO), ozone (O₃), hydrogen peroxide gas (H₂O₂), water vapour (H₂O) or vaporised methanol (CH₃OH), nitrogen-containing gases and/or aerosols, such as nitrous gases (NOₓ), dinitrogen oxide (N₂O), nitrogen (N₂), ammonia (NH₃) or hydrazine (H₂N₄).

In the method according to the present invention, the pretreatment may comprise pretreatment with an air-fed atmospheric plasma. This results in the formation of oxygen and/or nitrogen-containing functional groups on the surface(s) being pretreated.

Further discussion of plasma pretreatments is contained in US Patent Application Publication No. US 2008/0286514 A1 by Lam et al., which is incorporated herein by reference in its entirety.

In embodiments where the first thermal insulation layer 6 is directly adhered to the corrosion protection layer 2, the outer surface of the corrosion protection layer 2 may be activated by any of the pretreatment described above. Alternatively, or in addition to pretreatment of the corrosion protection layer 2, the first thermal insulation layer 6 may be pretreated immediately before the thermal insulation layer 6 comes into contact with the underlying corrosion protection layer 2. This pretreatment of the thermal insulation layer 6 may be used where the insulation layer 6 is extruded immediately before application to the pipe 1, for example in the form of a sheet, or where the insulation layer 6 is pre-formed in the form of a sheet or tape which is subsequently wound around the pipe 1.

The pipeline 10 illustrated in FIG. 1 includes a first (inner) thermal insulation layer 6 and a second (outer) thermal insulation layer 8. The first and second thermal insulation layers 6, 8 may have the same composition, or they may comprise dissimilar polymer materials such that they have different compositions. Furthermore, the first and second thermal insulation layers 6, 8 may be foamed to different degrees or densities, and may have the same or different thickness. This allows the system to be tailored for precise thermal insulation performance related to the system requirements of the installed application.

The thermal insulation layers 6, 8 are designed to exhibit adequate compressive creep resistance and compressive modulus at the operating temperatures of the pipeline, to prevent collapse of the foam structure in deep water installations, and hence maintain the required thermal insulation over the lifetime of the oil and gas recovery project. In addition, the compositions should be sufficiently ductile to withstand the bending strains experienced by the insulated pipe during reeling and installation operations.

The thickness of the first thermal insulation layer 6 is typically from about 30 to about 70 mm, for example from about 40 to about 60 mm, or about 50 mm, such that the temperature at the outer surface of the first thermal insulation layer 6 is from about 90 to about 140° C.

The first thermal insulation layer 6 may be foamed or solid. Where the first thermal insulation layer 6 is foamed, it may either be a blown foam or a syntactic foam having a degree of foaming of up to about 50%, for example from about 5% to about 30%.

The second thermal insulation layer 8 is provided over the first thermal insulation layer 6, and is comprised of a thermoplastic in the form of a solid, a blown foam or a syntactic foam. As mentioned above, the second thermal insulation layer 8 may be of the same or different composition as first thermal insulation layer 6, and may be of the same or different density and/or degree of foaming (including solid).

The second thermal insulation layer 8 may comprise any of the polysulfone materials mentioned herein. Alternatively, the second thermal insulation layer 8 may be selected from the group comprising: polypropylene, polybutylene, polyethylene, polystyrene and copolymers, blends and elastomers thereof.

Where the second thermal insulation layer 8 comprises a styrenic polymer, it may have the composition of any of the thermal insulations disclosed in US Patent Application Publication No. US 2009/0159146 A1 by Jackson et al., which is incorporated herein by reference in its entirety.

In an embodiment, the second thermal insulation layer 8 comprises high impact polystyrene. The composition of the second thermal insulation layer 8 is discussed in detail below.

The thickness of the second thermal insulation layer 8 is typically from about 20 to about 70 mm, for example from about 30 to about 50 mm, or about 35 mm.

The second thermal insulation layer 8 may be foamed or solid. Where the first thermal insulation layer 6 is foamed, it may either be a blown foam or a syntactic foam having a degree of foaming of up to about 50%, for example from about 5% to about 30%.

The first and second thermal insulation layers 6, 8 may be in direct contact with one another, or an intermediate layer 9 comprised of a polymeric material may be located between the first and second thermal insulation layers 6, 8 as shown in FIG. 1. The intermediate layer 9 may function as an adhesive which bonds the layers 6 and 8 together, and/or it may function as a heat barrier to permit the use of a thermoplastic with a lower softening point in the second thermal insulation layer 8.

The intermediate layer 9 may be in the form of a solid, a blown foam or a syntactic foam, and may have the same or different density and/or degree of foaming as the thermal insulation layers 6, 8. For example, the intermediate layer 9 may comprise a solid polymeric material which may be of the same or different composition as either one or both of the layers 6 and 8 and which functions as an adhesive between layers 6 and 8.

The intermediate layer 9 must firmly adhere to the first and second thermal insulation layers 6, 8. It may be necessary to apply an adhesive layer between the intermediate layer 9 and the first thermal insulation layer 6, and/or between the second thermal insulation layer 8 and the intermediate layer 9.

Alternatively, the inner surface of the intermediate layer 9 may be in contact with and bonded to the first thermal insulation layer 6 and/or the outer surface of the intermediate layer 9 may be in contact with and bonded to the second thermal insulation layer 8. For example, in the embodiment of FIG. 1, the intermediate layer 9 is in direct contact with and bonded to both the first thermal insulation layer 6 and the second thermal insulation layer 8 without the aid of adhesive layers. According to this embodiment, interlayer adhesion between layers 6, 8 and 9 may be achieved by surface activation of one or more of these layers by any of the pretreatment methods disclosed above, such as plasma pretreatment.

For example, to provide interlayer adhesion between the inner surface of intermediate layer 9 and the outer surface of first thermal insulation layer 6, at least one of the intermediate layer 9 (inner surface) and the first thermal insulation layer 6 (outer surface) may be surface activated by a pretreatment, such as plasma pretreatment, before being bonded together.

Similarly, to provide interlayer adhesion between the outer surface of intermediate layer 9 and the inner surface of second thermal insulation layer 8, at least one of the intermediate layer 9 (outer surface) and the second thermal insulation layer 8 (inner surface) may be surface activated by a pretreatment, such as plasma pretreatment, before being bonded together.

In the method according to the present invention, the pretreatment of any of layers 6, 8 and 9 may comprise pretreatment with an air-fed atmospheric plasma. This results in the formation of oxygen and/or nitrogen-containing functional groups on the surface(s) being pretreated.

The composition of the intermediate layer 9 will depend at least partly on the compositions of the thermal insulation layers 6, 8 to which it is bonded. For example, the composition of the intermediate layer 9 may comprise one or more of the polymeric materials which are disclosed herein as possible constituents of the first thermal insulation layer 6 or the second thermal insulation layer 8. Where the first thermal insulation layer 6 comprises a polysulfone and the second thermal insulation layer 8 comprises a polystyrene, the intermediate layer 9 may comprise at least one styrenic component such as high impact polystyrene, a styrene-maleic anhydride copolymer, and blends thereof. The composition of the intermediate layer 9 is discussed in detail below.

The thickness of the intermediate layer 9 is typically from about 2 to about 20 mm, for example from about 5 to about 15 mm, or about 10 mm. The intermediate layer 9 may be foamed or solid. Where the intermediate layer 9 is foamed, it may either be a blown foam or a syntactic foam having a degree of foaming of up to about 50%, for example from about 5% to about 30%.

An outer protective topcoat 7 may be applied over the thermal insulation layers 6, 8 to provide further resistance to static pressure at great depths, particularly if the insulation layers 6, 8 are foamed. The outer protective topcoat 7 may also function to provide weathering resistance, chemical resistance and mechanical protection during installation, and/or to improve the frictional characteristics of the insulation system.

The outer protective topcoat 7 may comprise the same or different polymeric materials as one or both of the thermal insulation layers 6, 8, or a modified or reinforced version thereof, but is preferably in a solid, unfoamed state. For example, where the second thermal insulation layer 8 comprises a solid or foamed polystyrene or styrene-based thermoplastic such as high impact polystyrene, the outer protective topcoat 7 may be comprised of a solid, unfoamed polystyrene or styrene-based thermoplastic, which may be at least one styrenic component selected from the group comprising polyethylene-modified polystyrene, styrene-butadiene block copolymer, and blends thereof. The composition of topcoat 7 is discussed in greater detail below.

The outer protective topcoat 7 must firmly adhere to the second thermal insulation layer 8. It may be necessary to apply an adhesive layer between the outer protective topcoat 7 and the second thermal insulation layer 8, particularly where the layers 7 and 8 are comprised of different polymeric materials. Alternatively, the inner surface of the outer protective topcoat 7 may be in contact with and bonded to the outer surface of the second thermal insulation layer 8. For example, in the embodiment of FIG. 1, the outer protective topcoat 7 is in direct contact with and bonded to the second thermal insulation layer 8 without the aid of adhesive layers. According to this embodiment, interlayer adhesion between layers 7 and 8 may be achieved by surface activation of one or more of these layers by any of the pretreatment methods disclosed above, such as plasma pretreatment.

It will be appreciated that the outer protective topcoat 7 may not be necessary in all embodiments of the invention, for example, where the outermost thermal insulation layer is a solid, or is foamed but naturally forms a solid skin.

The thickness of the outer protective topcoat 7 is typically from about 1 to about 10 mm, for example from about 3 to about 5 mm.

It is also necessary to provide thermal insulation around the joint area where two lengths of steel pipe are welded together. The composition of this pipe joint insulation system must be bondable to both the corrosion protection layer, or system, applied directly over the welded pipe joint and the existing thermal insulation layer, or layers, including any protective topcoats and any other layers of the insulated pipe exposed as a result of cutting back the insulation from the pipe ends to allow welding thereof. Methods for forming field joints between pipes are discussed in detail in US Patent Application Publication No. US 2011/0297316 A1 by Jackson et al., which is incorporated herein by reference in its entirety.

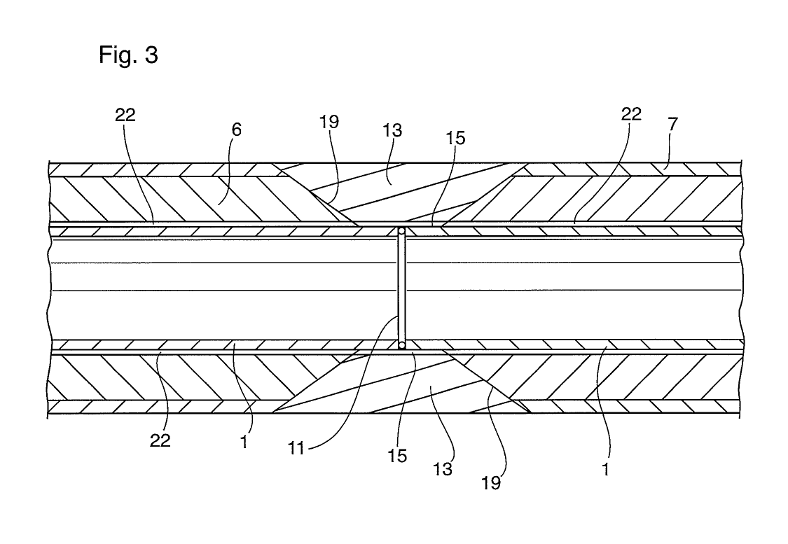

For example, FIG. 3 illustrates a longitudinal cross-section of a circular pipe joint weld area 11 at which two steel pipes 1 are joined, for example to form a portion of a pipeline.

In the manufacture of coated/insulated pipe, the ends of the pipe 1 must be left bare so as to prevent damage to the coating when the pipes 1 are joined in the field by welding. Typically, the main line coating is cut back from the end of the pipe to form chamfers which are spaced from the ends of the pipe. The chamfering step is typically performed in the factory as part of the manufacturing process.

Turning now to FIG. 3, the steel pipes 1 shown therein each have a main line coating comprising a corrosion protection layer 2, a thermal insulation layer 6 and an outer protective topcoat 7. As mentioned above, the main line coating is cut back at a distance from the ends of pipes 1, to form chamfered ends 19. Although FIG. 3 shows the pipes 1 having a specific main line coating, it will be appreciated that the pipes 1 could be provided with any of the insulating and protective coatings shown in the drawings or described herein.

The individual pipe sections 1 are joined together in the field to form a continuous pipeline. The joints between the pipe sections are known as “field joints”, and are formed by butt welding the pipe sections 1 together, and then applying a field joint insulation layer 13 over the weld area 11, i.e. the area of bare pipe surrounding the weld joint. These steps may be performed as the pipeline is being reeled onto or from a lay vessel (so called “tie-in joints”), during pre-fabrication of multi-jointed pipe strings, or immediately before laying of the pipeline.

After welding, the bare metal in the weld area 11 is provided with a field joint corrosion protection layer 15 which may have the same composition and thickness as any of the corrosion protection layers or systems described above, and which may have the same or different composition as the factory-applied corrosion protection layer 22 of the main line coating. A field joint insulation layer 13 is then applied over the corrosion protection layer 15 and over the chamfered ends 19, to substantially completely fill the weld area 11 to a thickness which is substantially the same as that of the mainline coating. The field joint insulation layer 13 applied to the weld area is a polysulfone as described herein, and may have the same or different composition as the factory-applied thermal insulation layer 6 and/or topcoat 7 of the main line coating.

To provide an effective field joint, the field joint insulation layer 13 is bonded to the field joint corrosion protection layer 15, and to the chamfered ends 19 of the mainline coating. In order to achieve sufficient bonding with the field joint insulation layer 13, the chamfered ends 19 of the main line coating may be surface activated so as to improve bonding with the polysulfone insulation layer 13. The surface activation may comprise a plasma or corona discharge pretreatment of the chamfered ends 19 of the main line coating immediately before application of the thermal insulation layer 13, and optionally before application of the field joint corrosion protection layer 15. The pretreatment creates reactive or polar chemical groups to which the polysulfone molecules of the field joint insulation layer 13 can form a strong bond. It may also be desired to heat the joint area 11 prior to application of the field joint insulation layer 13.

As for the method of application, the field joint insulation layer 13 may be applied to the joint area 11 by injection molding, for example by applying an annular mold over the joint area 11 and filling the mold cavity with the field joint insulation layer 13 in the form of a molten resin.

### Composition of Layers

### Corrosion Protection Layer (2)

The corrosion protection layer 2 may comprise an epoxy phenolic, a polyphenylene sulphide or a polyimide, including modified versions and blends thereof. In some cases, it has been found that an adhesive layer is not needed to bond the corrosion protection layer 2 to the pipe or to the first thermal insulation layer 6. Some of these materials can be used at higher service temperatures than conventional epoxy-based corrosion protection systems, such as those described in above-mentioned U.S. Pat. No. 8,397,765 by Jackson et al.

According to an embodiment of the invention, the corrosion protection layer 2 may comprise an epoxy, such as a fusion-bonded epoxy (FBE), which may be a high-temperature FBE. As shown in FIG. 1, the corrosion protection layer 2 may be applied directly to the outer surface of the steel pipe 1, such that the corrosion protection layer 2 is in contact with and bonded to the outer surface of the steel pipe 1.

The FBE coating is applied as a powder, for example by spraying, and the pipe is heated to a temperature of about 180-250 degrees Celsius to cause the particles of the FBE powder to fuse together and form a homogeneous coating. The pipe 1 may be heated before, during or after the application of the FBE.

The FBE is comprised of a high-temperature epoxy which is thermosetting such that it does not soften at elevated temperature, and which may comprise 100% solids. The FBE will typically withstand continuous operating temperatures of above about 200° C., for example temperatures of about 205 to about 220° C., as a standalone coating or in combination with a primer layer 3.

The FBE may comprise a commercial product such as Scotchkote 626-155™ by 3M, Nap-Gard 72555™ by DuPont, and Valspar Hot 150™. It will be appreciated that this is a limited list of FBE coatings which may be used in accordance with the present invention, and that other FBEs may also be suitable. For example, the high-temperature epoxy may comprise an epoxy novolac-based coating capable of continuous operation at or above about 200° C., wherein epoxy novolac resins comprise epoxy functional groups on a phenol formaldehyde backbone.

### Primer Layer (3)

The primer layer 3 may be comprised of any high temperature primer which bonds strongly to the steel pipe 1 and to the corrosion protection layer 2, while resisting high operating temperatures of the pipe 1. In an embodiment of the invention, the primer layer 3 comprises a liquid phenolic primer which is applied directly to the outer surface of pipe 1 in liquid form. The liquid phenolic primer is comprised of a phenol-formaldehyde resin and withstands operating (pipe) temperatures of over 200° C., for example temperatures of about 205 to about 220° C.

The liquid phenolic primer may comprise a commercial product such as Scotchkote 345™ by 3M, Valspar phenolic primer HXR 0015™, and Tuboscope TK 8007™. It will be appreciated that this is a limited list of primers which may be used in accordance with the present invention, and that other primers may also be suitable.

### Adhesive Layers

In cases where it is necessary to apply an adhesive layer between adjacent thermal insulation layers or between a thermal insulation layer and one or more of the other layers, including any solid protective layers, intermediate layers, topcoats, or corrosion protection layers, particularly layers of dissimilar composition, the adhesive material used should ideally bond equally well to said layers. The adhesives may comprise polymers with functionalities having mutual affinity to the layers requiring bonding, the functionalities being specific to the chemical composition of the layers requiring bonding. Preferably the bond strength should be high enough to promote cohesive failure between the individual layers.

The adhesive layer may also comprise a coextruded structure of two or more layers, the outer layers of which will bond to the respective insulation layers or topcoats with which they are compatible.

The adhesive layer between adjacent thermal insulation layers and between a thermal insulation layer and one or more of the other layers may, for example, comprise a grafted polymer or copolymer, or polymer blend with one or more moieties compatible with each of the individual layers to be bonded.

The adhesive layer is preferably applied by powder spray application, or side-wrap, crosshead extrusion or co-extrusion methods.

An additional adhesive layer would not be necessary where the two adjacent layers have a mutual affinity for each other, or where it is possible to achieve bonding of the layers using plasma or corona treatment, as described above.

For example, where the first thermal insulation layer 6 comprises a polysulfone, an adhesive layer may be provided between the first thermal insulation layer 6 and the underlying corrosion protection layer 2, and/or an adhesive layer may be provided between the first thermal insulation layer 6 and the adjacent intermediate layer 9.

For example, in an embodiment of the invention, an adhesive layer comprising a hydroxyl-functionalized polyethersulfone (PESU) may be used to adhere the first thermal insulation layer 6 to the underlying corrosion protection layer 2. The PESU may have a molecular weight of about 21,000 and may have hydroxyl end groups. The PESU adhesive layer 4 may be applied in powder form by spraying, the particles of the powder being fused together by heating. Examples of suitable PESU adhesives are available from Solvay Specialty Polymers under the trade name Veradel™.

A PESU adhesive layer of the same or similar composition may be provided between the first thermal insulation layer 6 and the adjacent intermediate layer 9.

An adhesive layer between adjacent layers and between a thermal insulation layer and one or more of the other layers may also comprise an olefin-based adhesive copolymer, for example a maleic anhydride functionalised ethylene copolymer. As discussed further below, such adhesive layers may be used between the intermediate layer 9 and the second thermal insulation layer 8, between thermal insulation layers 6 and 8 where they are in contact with one another, and/or between the second thermal insulation layer 8 and the outer protective topcoat 7.

### First Thermal Insulation Layer (6)

The first thermal insulation layer 6, being the insulation layer closest to the pipe 1, is designed to withstand operating temperatures in excess of the maximum operating temperatures of systems currently used for the thermal insulation of subsea pipelines, such as the systems described in above-mentioned U.S. Pat. No. 8,397,765 by Jackson et al. These operating temperatures may be as high as 270° C., but are typically within the range from about 200° C. to about 220° C.

For example, in an embodiment, the first thermal insulation layer 6 comprises a polysulfone having a Vicat softening point greater than 200° C. and a thermal conductivity of less than about 0.40 W/mK, for example a Vicat softening point in the range of about 200-230° C. and a thermal conductivity of about 0.15-0.35 W/mK.

Polysulfones are a family of amorphous thermoplastic polymers containing aryl groups bridged with sulfone groups, i.e. containing aryl-SO₂-aryl subunits. The polysulfone may include one or more other types of bridging groups such as ether and/or isopropylidene groups, and the polysulfone may also include biphenylene units.

For example, the polysulfone insulating and protecting coatings may be selected from one or more members of the group comprising:

(a) a polysulfone comprising sulfone, ether and isopropylidene bridging groups and having the following chemical structure:

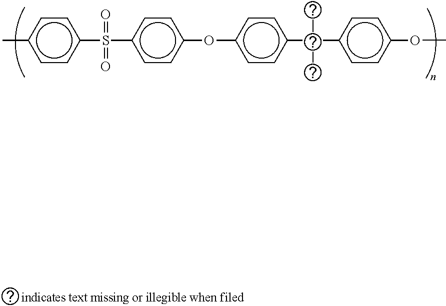

Examples of such polysulfones are UDEL® polysulfone and MINDEL® polysulfone blends by Solvay Advanced Polymers, LLC.
(b) a polyphenylsulfone comprising sulfone bridging groups, ether bridging groups and biphenylene groups, and having the following chemical structure:

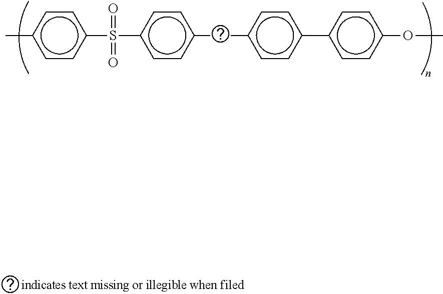

Examples of such polyphenylsulfones are RADEL® R polyphenylsulfone and ACUDEL® polyphenylsulfone blends by Solvay Advanced Polymers, LLC.
(c) a polyethersulfone comprising sulfone and ether bridging groups, and having a formula including at least one of the following repeating units:

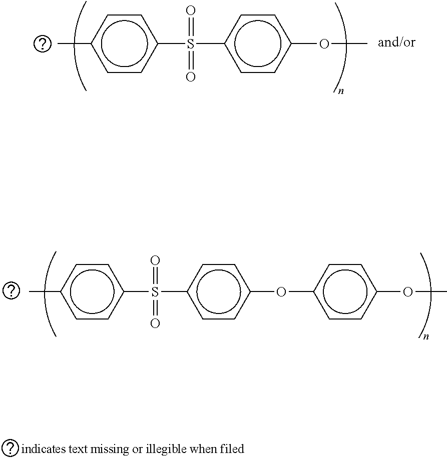

Examples of such polyethersulfones are RADEL® A polyethersulfone and VERADEL® polyethersulfone by Solvay Advanced Polymers, LLC.

Intrinsic material properties of the above thermoplastics are noted below in Table 1.

TABLE 1

| | Property | | | | | | | |
|---|---|---|---|---|---|---|---|---|
| | | | | | Heat | | | |
| | | | | | Deflection | | | |
| | | | | Vicat | Temperature, | Glass | | |
| | Tensile | Flexural | Thermal | Softening | (a)0.45 MPa | Transition | Compressive | Compressive |
| | Strength | Modulus | Conductivity | Point | (b)1.82 MPa | Temperature | Modulus | Strength |
| | (MPa) | (GPa) | (W/mK) | (° C.) | (° C.) | (° C.) | (GPa) | (MPa) |
| | Test Method | | | | | | | |
| Material | D 638 | D790 | E 1530 | D 1525B | D 648 | DSC | D 695 | D 695 |
| RADEL A | 83-126 | 2.6-8.6 | 0.24-0.30 | 215-218 | (a) 214-220 | 220 | 2.68-7.72 | 100-177 |
| (polyethersulfone) | | | | | (b) 204-216 | | | |
| RADEL R | 70-120 | 2.4-8.1 | 0.30 | — | (a) 214 | 220 | — | 99 |
| (polyphenylsulfone) | | | | | (b) 207-210 | | | |
| ACUDEL | 70-77 | 2.5-2.8 | 0.24 | — | (b) 197-207 | 220 | — | — |
| (polysulfone | | | | | | | | |
| blend) | | | | | | | | |

The polysulfones for use in the present invention have better thermal capability, chemical resistance and mechanical properties at temperatures above 200° C., as compared to other pipe insulation materials. Also, the different structures of polysulfones provide insulating materials having different properties. For example, the phenylene ether segment contributes flexibility to the polymer backbone, to provide the polymer with toughness, elongation and ductility, and the sulfone bridging groups provide elevated long-term use temperatures.

For example, the first thermal insulation layer 6 may have one or more of the following properties:

compressive creep resistance of less than about 10%, for example less than about 7%, at a temperature of about 205° C.;

compressive modulus of at least about 1500 MPa;

compressive strength of at least about 95 MPa;

thermal conductivity of less than about 0.40 W/mK; and

long term temperature withstand capability of at least about 200° C. (the temperature at the outer surface of the corrosion protection layer 2).

It will be appreciated that the insulated pipelines according to the invention may comprise one or more additional thermal insulation layers comprised of polysulfone, in addition to the first thermal insulation layer 6.

### Second Thermal Insulation Layer (8)

The second thermal insulation layer 8 may comprise any of the styrenic insulations as disclosed in above-mentioned US Patent Application Publication No. US 2009/0159146 A1 by Jackson et al. Alternatively, the second thermal insulation layer 8 may comprise a polypropylene, including polypropylene homopolymer, copolymers, blends and/or elastomers, the polypropylene optionally being crosslinked or partially crosslinked.

The second insulating and thermal insulation layer 8 is designed to withstand operating temperatures from about 90 to about 140° C., for example up to about 100° C. with styrenic insulations. It is also designed to exhibit adequate compressive creep resistance and modulus at these temperatures to prevent collapse of the foam structure and hence maintain the required thermal insulation over the lifetime of the oil and gas recovery project. In addition, the compositions should be sufficiently ductile to withstand the bending strains experienced by the insulated pipe during reeling and installation operations.

Where the second thermal insulation layer 8 is styrenic, it may be prepared from polystyrene or styrene-based thermoplastics, including polystyrene homopolymer, polystyrene copolymer, and modified polystyrene, where the polystyrene is blended, grafted or copolymerized with butadiene, polybutadiene, styrene-butadiene, styrene-butadiene-styrene, styrene-isoprene-styrene, styrene-ethylene/butylene-styrene, ethylene, ethylene-propylene, acrylonitrile, butadiene-acrylonitrile, α-methyl styrene, acrylic ester, methyl methacrylate, maleic anhydride, polycarbonate, or polyphenylene ether.

For example, the thermal insulation composition used in the second thermal insulation layer 8 exhibits one or more of the following properties:

compressive creep resistance of less than about 10%, for example less than about 7%, at a temperature of about 90° C. to about 140° C.;
compressive modulus of at least about 1500 MPa;
compressive strength of at least about 95 MPa;
thermal conductivity of less than about 0.40 W/mK; and
long term temperature withstand capability of at least about 90° C., which may be the temperature at the outer surface of the intermediate layer 9.

### Intermediate Layer (9)

As mentioned above, the intermediate layer 9 functions as an adhesive layer between the first and second thermal insulation layers 6, 8, and may also function as a heat barrier between the polysulfone of the first thermal insulation layer 6 and a polymeric material with a lower softening point which may comprise the second thermal insulation layer 8.

The intermediate layer 9 may have a Vicat softening point lower than that of the first thermal insulation layer 6 and higher than that of the second thermal insulation layer 8, and may also have one or more of the following properties:

density of about 1030-1050 kg/m³ (solid);

Vicat softening point of at least about 125° C.; and

long term temperature withstand capability of at least about 120° C., which may be the temperature at the outer surface of the first thermal insulation layer 6.

The composition of the intermediate layer 9 will depend at least partly on the compositions of the thermal insulation layers 6, 8 to which it is bonded.

Where the first thermal insulation layer 6 comprises a polysulfone and the second thermal insulation layer 8 comprises a polystyrene, the intermediate layer 9 may comprise at least one styrenic component such as high impact polystyrene, a styrene-maleic anhydride copolymer, and blends thereof. For example, in an embodiment, the intermediate layer 9 may comprise a blend of the high impact polystyrene and the styrene-maleic anhydride copolymer mentioned above.

Where the first thermal insulation layer 6 comprises a polysulfone and the second thermal insulation layer 8 comprises a polypropylene, the intermediate layer 9 may comprise a liquid epoxy or a fusion-bonded epoxy (FBE). The FBE coating is applied as a powder, for example by spraying, and the pipe and the first insulation layer 6 are heated to a temperature of about 180-240° C. to cause the particles of the FBE powder to fuse together and form a homogeneous coating which is bonded to the first insulation layer. The FBE of the intermediate layer 9 may have a composition which is the same or similar to the FBE of corrosion protection layer 2 described above.

Where layer 9 comprises a liquid epoxy layer, the liquid epoxy may be formed by premixing the resin and hardener components of a two-part liquid epoxy primer, and then applying the mixture to the joint area using a spray, brush, roller or pad. The epoxy primer may include a solvent, although 100% solids (solventless) primers may be used. Examples of 100% solids (solventless) epoxy primers which may be used in the method of the invention include epoxy primers produced by Canusa-CPS, such as those known as E Primer, S Primer and P Primer.

Where the second thermal insulation layer 8 comprises a polypropylene and the intermediate layer 9 comprises a liquid epoxy or FBE, an adhesive layer may be provided between the intermediate layer 9 and the second thermal insulation layer 8. The adhesive layer may comprise an olefin-based adhesive copolymer, such as a maleic anhydride functionalised polyolefin, and may be applied directly to the partially cured epoxy, prior to application of the second thermal insulation layer 8. For example, the adhesive may comprise a propylene-maleic anhydride copolymer.

### Outer Protective Topcoat (7)

The outer protective topcoat 7 is comprised of one or more layers of foamed or unfoamed polymeric material. In some embodiments, the outer protective topcoat 7 is prepared from the same or similar material as the underlying second thermal insulation layer 8, such as polypropylene, polystyrene or styrene-based thermoplastics, or modified or reinforced versions thereof. Preferred topcoat materials include polypropylene, high impact polystyrene, or high impact polystyrene modified with styrene-ethylene/butylene-styrene copolymer or polyethylene.

In an embodiment, the outer protective topcoat 7 comprises at least one styrenic component selected from the group comprising polyethylene-modified polystyrene, styrene-butadiene block copolymer, and blends thereof. The outer protective topcoat may further comprise one or more additives selected from antioxidants and pigments. The density of the topcoat may be from about 1,000-1,050 kg/m³.

In another embodiment, particularly where the second thermal insulation layer 8 comprises polypropylene, the outer protective topcoat 7 may comprise one or more layers of solid polypropylene or foamed polypropylene, the polypropylene of layer 7 having a composition which is the same or different from the polypropylene of layer 8. Where the outer protective topcoat 7 comprises foamed polypropylene, it may be a syntactic foam having a degree of foaming of up to about 50%, for example from about 5% to about 30%, and the layer 7 may be provided with a further barrier layer comprising solid polypropylene.

It may be required, for example, to impart a higher degree of physical or chemical performance, such as impact, abrasion, crush or moisture resistance, to the outer surface of the insulated pipe, in which case it may be advantageous to prepare the outer protective topcoat from a polymeric material having superior impact, abrasion, crush or chemical resistance to that from which the thermal insulation layer, or layers, is made. Such a material may comprise the thermal insulation material blended with suitable polymeric modifiers, compatibilisers, or reinforcing fillers or fibres, or it may comprise a dissimilar, preferably compatible, polymeric material. In the latter case, it may be necessary to apply an additional adhesive layer between the final thermal insulation layer and topcoat to effect adequate bonding of the two layers.

Also, as mentioned above, the insulation layers may comprise dissimilar materials, or materials foamed to different degrees. The thermal insulation layers may also be foamed to different degrees the further they are away from the pipe wall; for example, outer layers of insulation may be foamed to progressively higher degrees than inner layers to provide tailored thermal performance of the system.

Thermal insulation compositions prepared from these materials may also contain additives selected from one or more members of the group comprising inorganic fillers, reinforcing fillers or fibres, nano-fillers, conductive fillers, flame-retardant fillers, antioxidants, heat-stabilisers, process aids, compatibilisers, and pigments. For example, reinforcement of polysulfones with glass fibers in amounts ranging from about 20-30 percent by weight provides higher stiffness, dimensional stability, and creep resistance.

### Foaming Agents

Foamed thermal insulation layers in the insulating and protective coatings according to the invention can be prepared from the aforementioned high temperature resistant thermoplastics, by incorporating chemical foaming agents, by the physical injection of gas or volatile liquid, or by blending with hollow polymer, glass or ceramic microspheres. Foams generated through the action of chemical or physical foaming agents are generally referred to as “blown” foams. Foams containing hollow microspheres are referred to as “syntactic” foams.

Syntactic foams provide superior compressive creep and crush resistance than blown foams, but are generally less efficient thermal insulators and are considerably more expensive. A cost and performance optimized design may, for example, comprise one or more layers of syntactic foam surrounded by one or more layers of blown foam insulation.

Chemical foaming agents may function via either an endothermic (heat absorbing) or exothermic (heat generating) reaction mechanism. They are selected from one or more members of the group comprising sodium bicarbonate, citric acid, tartaric acid, azodicarbonamide, 4,4-oxybis(benzene sulphonyl) hydrazide, 5-phenyl tetrazole, dinitrosopentamethylene tetramine, p-toluene sulphonyl semicarbazide, or blends thereof. Preferably the chemical foaming agent is an endothermic foaming agent, such as sodium bicarbonate blended with citric or tartaric acid.

Chemical foaming occurs when the foaming agent generates a gas, usually CO₂ or N₂, through decomposition when heated to a specific decomposition temperature. The initial decomposition temperature along with gas volume, release rate and solubility are important parameters when choosing a chemical foaming agent and they need to be carefully matched to the melt processing temperature of the particular thermoplastic being foamed.

For physical foaming, the gas or volatile liquid used is selected from the group comprising CO₂, supercritical CO₂, N₂, air, helium, argon, aliphatic hydrocarbons, such as butanes, pentanes, hexanes and heptanes, chlorinated hydrocarbons, such as dichloromethane and trichloroethylene, and hydrochlorofluorocarbons, such as dichlorotrifluoroethane. In the case of volatile liquids, foaming occurs when the heated liquid vaporizes into gas. Preferably the physical foaming agent is supercritical CO₂.

The hollow microspheres are selected from one or more members of the group comprising glass, polymeric, or ceramic, including silica and alumina, microspheres. Preferably the hollow microspheres are lime-borosilicate glass microspheres.

### Thermal Insulation Application Process

The foamed or unfoamed thermal insulation layers 6, 8, the intermediate layer 9 and the outer protective topcoat 7 may be applied to the steel pipe or a pipeline, preferably over the corrosion protection layer 2, by sidewrap or crosshead extrusion, or co-extrusion, processes.

Alternatively, any of the foamed or unfoamed layers may be applied as a fusion bonded powder by spraying the pipe with powder-spray guns, passing the pipe through a “curtain” of falling powder, or using a fluidized bed containing the powder, or, b) as a liquid coating using liquid-spray guns. Melt fusion of the powder results from contact with the hot pipe.

Extrusion may be accomplished using single screw extrusion, either in single or tandem configuration, or by twin-screw extrusion methods. In the case of single screw extrusion, the extruder screw may be either single stage or 2-stage design.

A single stage compression screw would be adequate for chemical foam extrusion whereby the foaming agent is added as a pelleted concentrate or masterbatch which is pre-mixed with the polymer to be foamed using a multi-component blender, for example, mounted over the main feed port of the extruder. The design of the screw is important and it may incorporate barrier flights and mixing elements to ensure effective melting, mixing, and conveying of the polymer and foaming agent.

With a 2-stage screw, the first and second stages are separated by a decompression zone, at which point a gas or liquid physical foaming agent can be introduced into the polymer melt via an injection or feed port in the extruder barrel. The first stage acts to melt and homogenize the polymer, whereas the second stage acts to disperse the foaming agent, cool the melt temperature, and increase the melt pressure prior to the melt exiting the die. This may also be accomplished by tandem extrusion, wherein the two stages are effectively individual single screw extruders, the first feeding into the second. A 2-stage screw is also preferred for the extrusion of polymers which have a tendency to release volatiles when melted, or are hygroscopic, the extruder barrel then being equipped with a vent port positioned over the decompression zone through which the volatiles or moisture can be safely extracted.

Twin screw extrusion is preferred where the polymer to be foamed is shear sensitive or if it is required that fillers or other additives be incorporated into the insulation composition. It is particularly recommended for the extrusion of syntactic foams or blown foams prepared by the physical injection of a gas or liquid foaming agent. Since the twin screw design is typically modular, comprising several separate and interchangeable screw elements, such as mixing and conveying elements, it offers great versatility with respect to tailoring the screw profile for optimum mixing and melt processing.

In the case of syntactic foams, for example, the hollow microspheres are fed directly into the polymer melt using a secondary twin-screw feeder downstream of the main polymer feed hopper. An additional consideration with syntactic foams is potential breakage of the hollow microspheres during extrusion of the foam. Shear and compressive forces inside the extruder need to be minimized during processing of the foam to prevent this through judicious design of the extruder screw(s), barrels, manifolds and dies.

A static mixing attachment or gear pump may be inserted between the end of the screw and the die to further homogenize the melt, generate melt pressure, and minimize melt flow fluctuations.

For chemically or physically blown foams, the degree of foaming is dependent upon the required balance of thermal conductivity and compressive strength. Too high a degree of foaming, whilst beneficial for thermal insulation performance, may be detrimental to the compressive strength and creep resistance of the foam. The thermal insulation layers 6, 8 of the present invention may be solid or foamed from about 5% to about 50%, more preferably 5% to 30%, or 10% to 25%. The degree of foaming is defined herein as the degree of rarefaction, i.e. the decrease in density, and is defined as [(Dmatrix−Dfoam)/Dmatrix]×100. Expressed in this way, the degree of foaming reflects the volume percentage of gas under the assumption that the molecular weight of gas is negligible compared to that of the matrix, which is generally true. Alternatively, the degree of foaming can be measured visually by microscopic determination of cell density.

With respect to the particular foam insulations described herein, it is important that conditions of mixing, temperature and pressure are adjusted to provide a uniform foam structure comprising very small or microcellular bubbles with a narrow size distribution evenly distributed within the polymer matrix, in order to ensure maximum compressive strength, thermal performance and compressive creep resistance of the insulation when subjected to high external pressures and pressures. Also, when extruding blown foam insulation it is important that foaming be prevented until the polymer exits the extrusion die.

Actual coating of the pipe may be accomplished using an annular crosshead die attached to the thermal insulation extruder through which the pre-heated pipe, with a prior-applied corrosion protection layer or multi-layer corrosion protection system, is conveyed, the thermal insulation thereby covering the entire surface of the pipe by virtue of the annular die forming said thermal insulation into a tubular profile around the conveyed pipe.

Alternatively, the thermal insulation may be applied by a side-wrap technique whereby the thermal insulation is extruded through a flat strip or sheet die. The thermal insulation is extruded in the form of a sheet or tape which is then wrapped around the pipe. It may be necessary to apply a number of wraps to achieve the required thermal insulation thickness and, hence, performance. The individually wrapped layers are fused together by virtue of the molten state of the material being extruded. It may also be necessary to preheat the outer surface of the previous layer to ensure proper adhesion of any subsequent layer.

The application of thermal insulation by the side-wrap technique may involve wrapping the pipe as it is simultaneously rotated and conveyed forwardly along its longitudinal axis, as described above. It may also involve the application of a pre-extruded tape using rotating heads while the pipe is conveyed longitudinally but not rotated. In this particular case, the winding angle of the thermal insulation layers can be adjusted by varying the speed of pipe movement in the longitudinal direction and/or by varying the rotational speed of the pipe or the rotating heads. The tape may be wound in successive layers at opposite winding angles to maintain neutrality of the pipe, until the required thickness has been built up. Furthermore, it may be desired that the applied layers of thermal insulation do not become joined and that they are able to slide over each other with little resistance in order to avoid increasing bend stiffness or bend dynamics.

If it is necessary to apply an adhesive layer between the corrosion protection layer 2 and the first thermal insulation layer 6, or between one of the thermal insulation layers 6, 8 and the intermediate layer 9 or the outer protective topcoat 7, this can be accomplished using either a single layer sheet or annular die, or a co-extrusion die whereby a multi-layer adhesive or the adhesive and thermal insulation layers are applied simultaneously. The outer protective topcoat 7, if necessary, may be similarly applied.

In a process according to the invention, a polysulfone polymer comprising the first thermal insulation layer 6 is extruded in the form of a thin sheet having an inner surface and an outer surface. The sheet is then wrapped around a cylindrical substrate such that the inner surface of the sheet is brought into contact with the outer surface of the cylindrical substrate. The sheet is wrapped around the substrate a number of times until the first thermal insulation layer 6 is built up to the desired thickness as discussed above, with the wraps overlapping along the length of the substrate.

The cylindrical substrate may comprise the steel pipe 1 with a corrosion protection layer 2 applied to its outer surface. The corrosion protection layer 2 may comprise FBE as described above. A primer layer 3 may be provided between the pipe 1 and the corrosion protection layer 2.

The polysulfone polymer has a Vicat softening point greater than 200° C., and both the outer surface of the cylindrical substrate and the sheet of polysulfone polymer are maintained at a temperature above the Vicat softening point of the polysulfone polymer during the wrapping step. This helps to ensure proper fusion and bonding of the sheet to the underlying substrate and to itself.

During the step of wrapping the sheet of polysulfone polymer around the substrate, at least one of the substrate and the inner surface of the sheet is activated by a pretreatment, immediately before the sheet is brought into contact with the substrate. For example, an area of the inner surface of the polysulfone sheet is activated by the pretreatment immediately before that area of the sheet is brought into contact with the outer surface of the substrate. Any of the pretreatments mentioned above may be used. Typically the pretreatment will be a plasma pretreatment.

As mentioned above, the sheet of polysulfone may be wrapped around the substrate a number of times until the first thermal insulation layer 6 is built up to the desired thickness. The plasma pretreatment need only be applied for the first wrap, i.e. to those portions of the inner surface of the sheet of polysulfone which are brought into direct contact with the corrosion protection layer 2. There is no need to pretreat the outer surface of the substrate or the inner surface of the polysulfone sheet for the second and subsequent wraps.

### Pipe Joint Insulation System

The pipe joint insulation system referred to in FIG. 3 comprises a high temperature resistant polysulfone insulation layer 13, identical or similar in composition to the thermal insulation layer, or layers, and which is bondable to the corrosion protection layer or system 15, the existing thermal insulation layer, or layers 6, and the topcoat 7.

The pipe joint insulation system also comprises a corrosion protection layer 15, which may have a single or multi-layer structure. For example, the corrosion protection layer is similar or identical to the corrosion protection layer 2, with or without a primer layer 3, as described above.

### Example 1

### Thermal Conductivity Testing

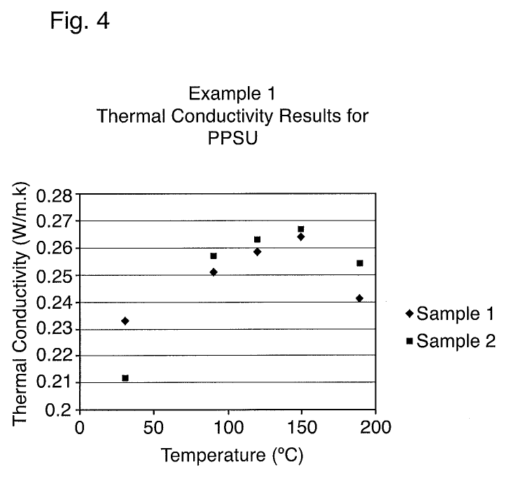

Thermal conductivity testing was performed on two identical samples of polyphenylsulfone (Samples 1 and 2) at temperatures of 30° C., 90° C., 120° C., 150° C. and 190° C. The thermal conductivity of each sample was tested in accordance with ASTM Standard C518-04: “Standard Test Method for Steady-State Thermal Transmission Properties by Means of the Heat Flow Meter Apparatus”. Samples 1 and 2 each had a thickness of 5.96 mm and diameter of 57.73 mm. The results of the thermal conductivity testing of Example 1 are shown in Table 2 below, and in FIG. 4.

### Example 2

### Thermal Conductivity Testing

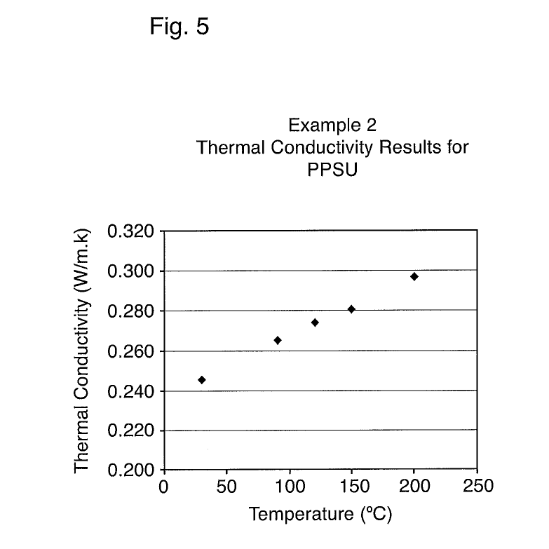

Thermal conductivity testing was performed on two identical samples of polyphenylsulfone (Samples 3 and 4) at temperatures of 30° C., 90° C., 120° C., 150° C. and 200° C. Samples 1 to 4 all had the same composition. The results of the thermal conductivity testing of Example 2 are shown in Table 2 below, and in FIG. 5.

TABLE 2

| | Thermal Conductivity (W/m · K) | | |
|---|---|---|---|
| Temperature (° C.) | Sample 1 | Sample 2 | Samples 3, 4 |
| 30 | 0.233 | 0.212 | 0.246 |
| 90 | 0.251 | 0.257 | 0.265 |
| 120 | 0.258 | 0.263 | 0.274 |
| 150 | 0.264 | 0.267 | 0.280 |
| 190 | 0.241 | 0.254 | NA |
| 200 | NA | NA | 0.297 |

### Example 3

### Long-Term Heat Flow Testing

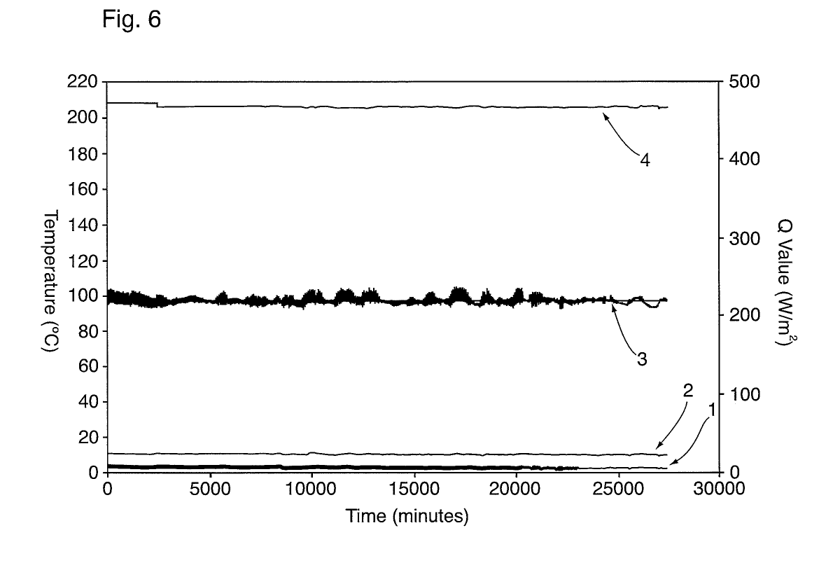

Long-term heat flow testing at 205° C. was conducted in order to test the effectiveness and the stability of the insulation system. The test samples consisted of three layers, a steel plate to simulate a pipe; a first thermal insulation layer comprised of polyphenylsulfone, and a second thermal insulation layer comprised of a high impact polystyrene. The steel plate was heated to simulate hot fluid flowing through a pipe; and the outer surface of the second thermal insulation layer was in contact with cold water to simulate a subsea environment. The results of the testing are shown in FIG. 6, in which:
1 represents the temperature of the water in contact with the outer surface of the second thermal insulation layer;
2 represents the temperature of the outer surface of the second thermal insulation layer;
3 represents the Q value, representing heat flow through the two insulation layers; and
4 represents the temperature of the steel plate.

It can be seen from FIG. 6 that the Q value of the thermal insulation system remains stable with time.

Although the invention has been described in connection with certain embodiments, it is not limited thereto. Rather, the invention includes all embodiments which may fall within the scope of the following claims.

What is claimed is:

1. An insulated high-temperature transport conduit for use in offshore, deep water environments, the conduit comprising:
(a) a continuous steel pipe made up of one or more pipe sections, wherein the steel pipe has an outer surface and an inner surface;
(b) a corrosion protection layer provided over the outer surface of the steel pipe; and
(c) a first thermal insulation layer provided over the corrosion protection layer, wherein the first thermal insulation layer comprises a polysulfone having a Vicat softening point greater than 200° C. and a thermal conductivity of less than about 0.40 W/mK.

2. The insulated high-temperature transport conduit according to claim 1, wherein the polysulfone comprises phenyl groups bridged by sulfone, ether and isopropylidene bridging groups.

3. The insulated high-temperature transport conduit according to claim 1, wherein the polysulfone comprises a polyphenylsulfone.

4. The insulated high-temperature transport conduit according to claim 1, wherein the first thermal insulation layer has a thickness of about 30 to about 70 mm.

5. The insulated high-temperature transport conduit according to claim 4, wherein the first thermal insulation layer has a thickness of about 40 to about 60 mm.

6. The insulated high-temperature transport conduit according to claim 1, wherein the first thermal insulation layer is solid.

7. The insulated high-temperature transport conduit according to claim 1, wherein the first thermal insulation layer is a blown foam or a syntactic foam having a degree of foaming of up to about 50%.

8. The insulated high-temperature transport conduit according to claim 7, wherein the degree of foaming of the first thermal insulation layer is from 5-30%.

9. The insulated high-temperature transport conduit according to claim 1, wherein the first thermal insulation layer has one or more of the following properties:
compressive creep resistance of less than about 10% at a temperature of about 205° C.;
compressive modulus of at least about 1500 MPa;
compressive strength of at least about 95 MPa;
thermal conductivity of less than about 0.40 W/mK; and
long term temperature withstand capability of at least about 200° C.

10. The insulated high-temperature transport conduit according to claim 1, wherein the polysulfone has a Vicat softening point in the range of about 200-230° C. and a thermal conductivity of about 0.15-0.35 W/mK.

11. The insulated high-temperature transport conduit according to claim 1, wherein the corrosion protection layer comprises an epoxy.

12. The insulated high-temperature transport conduit according to claim 11, wherein the fusion-bonded epoxy is a high temperature fusion-bonded epoxy capable of continuous operation at about 200° C., or an epoxy novolac based coating capable of continuous operation at or above about 200° C.

13. The insulated high-temperature transport conduit according to claim 1, wherein the corrosion protection layer is in contact with, and bonded to, the outer surface of the steel pipe.

14. The insulated high-temperature transport conduit according to claim 1, further comprising a primer layer which is in contact with and directly bonded to the outer surface of the steel pipe, wherein the corrosion protection layer is in contact with and bonded to the primer layer.

15. The insulated high-temperature transport conduit according to claim 14, wherein the primer layer comprises a phenolic primer.

16. The insulated high-temperature transport conduit according to claim 15, wherein the phenolic primer comprises a phenol-formaldehyde resin.

17. The insulated high-temperature transport conduit according to claim 1, wherein the first thermal insulation layer is in contact with and bonded to the corrosion protection layer.

18. The insulated high-temperature transport conduit according to claim 17, at least one of the corrosion protection coating and the first thermal insulation layer having been surface activated by a pretreatment before being bonded together.

19. The insulated high-temperature transport conduit according to claim 18, wherein the pretreatment comprises surface treatment by plasma or corona discharge.

20. The insulated high-temperature transport conduit according to claim 18, wherein the first thermal insulation layer is subjected to said pretreatment.

21. The insulated high-temperature transport conduit according to claim 17, wherein the first thermal insulation layer is bonded to the corrosion protection layer by an adhesive layer.

22. The insulated high-temperature transport conduit according to claim 21, wherein the adhesive layer comprises a hydroxyl-functionalized polyethersulfone.

23. The insulated high-temperature transport conduit according to claim 1, further comprising a second thermal insulation layer provided over the first thermal insulation layer, wherein the second thermal insulation layer is comprised of a thermoplastic in the form of a solid, a blown foam or a syntactic foam.

24. The insulated high-temperature transport conduit according to claim 23, wherein the thermoplastic comprising the second thermal insulation layer is selected from the group comprising: polypropylene, polybutylene, polyethylene, polystyrene and copolymers, blends and elastomers thereof.

25. The insulated high-temperature transport conduit according to claim 24, wherein the polystyrene comprises high impact polystyrene.

26. The insulated high-temperature transport conduit according to claim 23, wherein the second thermal insulation layer has a thickness of about 20 to about 70 mm.

27. The insulated high-temperature transport conduit according to claim 23, wherein the second thermal insulation layer is solid.

28. The insulated high-temperature transport conduit according to claim 23, wherein the second thermal insulation layer is a blown foam or a syntactic foam having a degree of foaming of up to about 50%.

29. The insulated high-temperature transport conduit according to claim 23, wherein the second thermal insulation layer has one or more of the following properties:
compressive creep resistance of less than about 10% at a temperature of about 90° C. to about 140° C.;
compressive modulus of at least about 1500 MPa;
compressive strength of at least about 95 MPa;
thermal conductivity of less than about 0.40 W/mK; and
long term temperature withstand capability of at least about 90° C.

30. The insulated high-temperature transport conduit according to claim 23, further comprising an intermediate layer comprised of a polymeric material, wherein the intermediate layer is located between the first thermal insulation layer and the second thermal insulation layer.

31. The insulated high-temperature transport conduit according to claim 30, wherein the polymeric material comprising the intermediate layer is solid.

32. The insulated high-temperature transport conduit according to claim 30, wherein the intermediate layer comprises at least one styrenic component selected from high impact polystyrene, a styrene-maleic anhydride copolymer, and blends thereof.

33. The insulated high-temperature transport conduit according to claim 32, wherein said intermediate layer has a thickness of about 2 to about 20 mm.

34. The insulated high-temperature transport conduit according to claim 30, wherein the intermediate layer has one or more of the following properties:
density of about 1030-1050 kg/m³;
Vicat softening point of at least about 125° C.; and
long term temperature withstand capability of at least about 120° C.

35. The insulated high-temperature transport conduit according to claim 30, wherein the intermediate layer is in contact with and bonded to one or both of the first thermal insulation layer and the second thermal insulation layer.

36. The insulated high-temperature transport conduit according to claim 35, wherein the intermediate layer is in contact with and bonded to the first thermal insulation layer, at least one of the intermediate layer and the first thermal insulation layer having been surface activated by a pretreatment before being bonded together.

37. The insulated high-temperature transport conduit according to claim 35, wherein the intermediate layer is in contact with and bonded to the second thermal insulation layer, at least one of the intermediate layer and the second thermal insulation layer having been surface activated by a pretreatment before being bonded together, wherein the pretreatment comprises surface treatment by plasma or corona discharge.

38. The insulated high-temperature transport conduit according to claim 30, wherein the intermediate layer is bonded to one or both of the first thermal insulation layer and the second thermal insulation layer by an adhesive layer.

39. The insulated high-temperature transport conduit according to claim 23, further comprising an outer protective topcoat comprising an outermost layer of the conduit and provided over the second thermal insulation layer, wherein the outer protective topcoat comprises a thermoplastic polymer.

40. The insulated high-temperature transport conduit according to claim 39, wherein the outer protective topcoat is solid and comprises at least one styrenic component or polypropylene.

41. The insulated high-temperature transport conduit according to claim 40, wherein said at least one styrenic component is selected from polyethylene-modified polystyrene, styrene-butadiene block copolymer, and blends thereof.

42. The insulated high-temperature transport conduit according to claim 41, wherein said outer protective topcoat further comprises one or more additives selected from antioxidants and pigments.

43. The insulated high-temperature transport conduit according to claim 39, wherein said outer protective topcoat has a thickness of about 1 to about 10 mm.

44. The insulated high-temperature transport conduit according to claim 39, wherein the outer protective topcoat is in contact with and bonded to the second thermal insulation layer, at least one of the outer protective topcoat and the second thermal insulation layer having been surface activated by a pretreatment before being bonded together, wherein the pretreatment comprises surface treatment by plasma or corona discharge.

45. The insulated high-temperature transport conduit according to claim 39, wherein the outer protective topcoat is bonded to the second thermal insulation layer by an adhesive layer.

46. A process for preparing an insulated high-temperature transport conduit, comprising:
(a) providing a cylindrical substrate having an outer surface;
(b) extruding a sheet comprising a polysulfone polymer having a Vicat softening point greater than 200° C., the sheet having an inner surface and an outer surface;
(c) wrapping the sheet of polysulfone polymer around the cylindrical substrate so as to bring the inner surface of the sheet of polysulfone polymer into contact with the outer surface of the cylindrical substrate;
wherein, during said wrapping step, the inner surface of the sheet of polysulfone is activated by a pretreatment immediately before it is brought into contact with the outer surface of the cylindrical substrate.

47. The process according to claim 46, wherein both the outer surface of the cylindrical substrate and the sheet of polysulfone polymer are at a temperature above the Vicat softening point of the polysulfone polymer during the wrapping step.

48. The process according to claim 46, wherein the sheet is wrapped around the cylindrical substrate in overlapping fashion and in a plurality of layers.

49. The process according to claim 46, wherein the pretreatment comprises surface treatment by plasma or corona discharge.

50. The process according to claim 46, wherein the cylindrical substrate comprises a steel pipe and wherein the outer surface of the cylindrical substrate comprises a corrosion protection layer.
